(19) United States
(12) Patent Application Publication
(10) Pub. No.: US 2007/0206609 A1
(43) Pub. Date: Sep. 6, 2007

(54) Data Sharing in a Multimedia Communication System

(76) Inventors: Janne Peisa, Espoo (FI); Mats Sagfors, Kyrkslatt (FI); Johan Torsner, Masaby (FI); Stefan Wager, Gardsgrender (FI)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/570,682

(22) PCT Filed: Aug. 6, 2004
(86) PCT No.: PCT/EP04/51741

§ 371 Date: Jan. 2, 2007

(30) Foreign Application Priority Data
Sep. 12, 2003 (GB) 0321426.9

(51) Int. Cl. H04L 29/06

(52) U.S. Cl. 370/400

(57) ABSTRACT

Data Sharing in a Multimedia Communication System. A method of optimising the use of transmission bandwidth in a mobile radio communication system, the method comprising, for data to be sent via the air interface from a first to a second node, generating a signature for the data content, sending the signature from the first to the second node or to an intermediate node in the transmission path, at the second node or said intermediate node comparing the signature to signatures for data stored at that node, and sending the data from the first to the second node, via the air interface, only if the received signature does not match a signature for stored data.

### FIELD OF THE INVENTION

The present invention relates to combinational multimedia services and more particularly to a method of minimising traffic volume associated with such service.

### BACKGROUND OF THE INVENTION

IP Multimedia (IPMM) services provide a dynamic combination of voice, video, messaging, data, etc. within the same session. By growing the numbers of basic applications and the media which it is possible to combine, the number of services offered to the end users will grow, and the inter-personal communication experience will be enriched. This will lead to a new generation of personalised, rich multimedia communication services, including so-called “combinational IP Multimedia” services which are considered in more detail below.

IP Multimedia Subsystem (IMS) is the technology defined (in TS 32.225, Release 5) by the Third Generation Partnership Project (3GPP) to provide IP Multimedia services over 3G mobile communication networks. IMS provides key features to enrich the end-user person-to-person communication experience through the integration and interaction of services. IMS allows new rich person-to-person (client-to-client) as well as person-to-content (client-to-server) communications over an IP-based network. The IMS makes use of the Session Initiation Protocol (SIP) and Service Delivery Protocol (SDP) to set up and control calls or sessions between user terminals (or user terminals and web servers). IMS sits on top of an access network which might be a Universal Mobile Telecommunications System (UMTS) or a General Packet Radio Service (GPRS/GSM) network but which might use some alternative technology, e.g. WiFi. FIG. 1 illustrates schematically how the IMS fits into the mobile network architecture in the case of a GPRS access network.

Push-to-Watch is a generic name given to an IP multimedia service which allows users to share pictures during a voice call. The service may be generalised to cover a combinational IP Multimedia service that includes and combines both a Circuit Switched media (such as voice) and a Packet Switched media over the IP Multimedia domain (such as pictures, video, presence, instant messages, etc.). This generalised service is referred to here as “WeShare”. The service enables a user, during a Circuit Switched (CS) voice conversation with another user, to take a picture, a video or audio clip, etc. and to share this content with other users in (near) real time. Either party in the conversation may initiate transmission of content to the other party. The possibility of sharing a picture or other multimedia information will most likely result in longer phone calls, which will increase network operator revenues, even if the transmission of the actual media is free.

In the case of picture sharing, it is assumed that the parties to a WeShare service would like to be able to see the same picture at substantially the same time and that the time to transmit the picture between the parties should be minimised in order to ensure the best possible end-user experience. From the operator's point of view (especially if the transmission of the picture is cheap or free), the amount of data transmitted should be minimized in order to save network capacity for services with higher revenue per bit.

### SUMMARY OF THE INVENTION

According to a first aspect of the present invention there is provided a method of optimising the use of transmission bandwidth in a communication system, the method comprising, for data to be sent via an interface from a first to a second node, generating a signature for the data content, sending the signature from the first to the second node or to an intermediate node in the transmission path, at the second node or said intermediate node comparing the signature to signatures for data stored at that node, and sending the data from the first to the second node, via the said interface, only if the received signature does not match a signature for stored data.

Said communication network may be a mobile wireless communication network, said interface being the air interface.

Said data may be multimedia data which is sent during a circuit switched voice call between the first and the second nodes.

Embodiments of the present invention may give rise to the following advantages:

Sending a signature instead of the complete file will result in a quicker transmission time and thus improved end user perceived quality.

Sending a signature instead of the complete file will result in less data transmission, resulting in increased system capacity.

Storing data at a proxy server if appropriate will allow the customisation of data, e.g. pictures, for various user devices using the cheap and fast processing power available at server.

In a first embodiment of the invention, said first and second nodes are user terminals, and said intermediate node is present and acts as a proxy server, caching data which is sent between user terminals for the first time. In the event that the received signature matches a signature for stored or cached data, the data is sent to the second node by the intermediate node.

In a second embodiment of the invention, said second node is a user terminal and said first node is a node at which content is stored. Said signature is generated at the first node, and is sent to the second node. Based upon the signature comparison, the second node is able to determine whether or not it has already received the data which is intended to be sent. If the data has already been sent, the further sending can be aborted.

### BRIEF DESCRIPTION OF THE DRAWINGS

FIG. 1 illustrates a mobile communication system comprising an IMS core network; and

FIG. 2 illustrates signalling flows for the repeated sending of pictures (left) and for the sending of signatures in place of pictures (right).

### DETAILED DESCRIPTION OF CERTAIN EMBODIMENTS

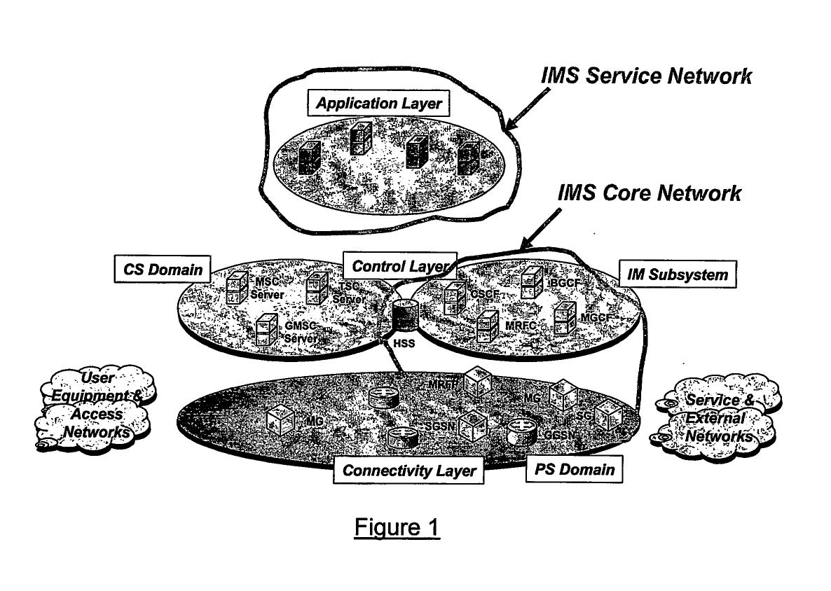

For the purpose of illustration, the following implementation of the invention is described in the context of a 3G cellular communications system in which network subscribers use mobile terminals such as is illustrated in FIG. 1. The exchange of data, in this example pictures, is carried out between mobile terminals. The terminals may be “attached” to the same operator network or to different networks. The or each network is provided with a “proxy” server (e.g. within the IP Multimedia System, IMS).

According to the current Push-to-Watch proposals, pictures are stored on the sender's mobile device. They are either taken directly with the device (e.g. in the case of a camera phone) or are transmitted from some other device to the mobile device (e.g. from a digital camera to the phone). In both cases the picture will most likely then be sent unmodified from the sender's device to the receiver's device (via various network nodes). The receiver's device renders the received picture into a form suitable for display on the receiving device.

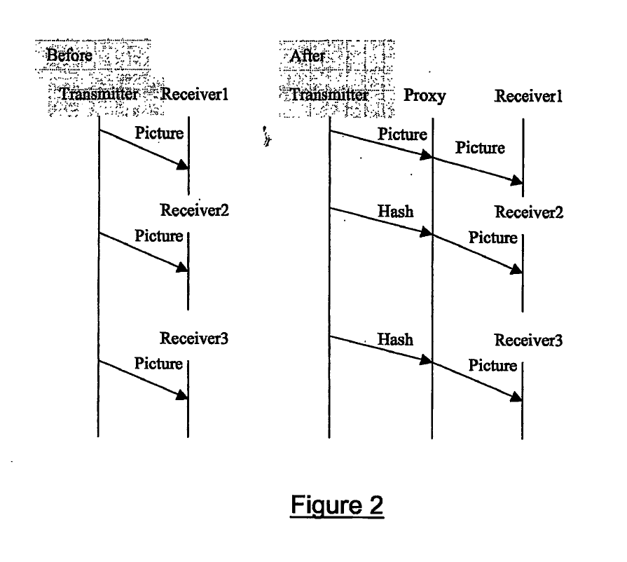

Often the picture that someone would like to share is special. It may be a unique moment in one's life (a picture of a new-born baby etc), or an especially entertaining picture (joke etc). It is likely that these kinds of pictures will be shared several times with different persons. If a picture is shared several times (as is illustrated in the left hand messaging flow of FIG. 2), the transmission resources required for a single transmission are consumed several times over. For high resolution pictures the consumed resources can be significant (for example, a picture taken using a high quality digital camera can result in the need to transmit around a megabyte of data). Furthermore, if the picture needs to modified (e.g. the size or the number of the colours needs to be reduced) to better suite the display capabilities of the receiver, the required processing must be done either in the sending or receiving mobile terminal, which will result in the need for high computational effort at one of the terminals (resulting in turn in processing delays).

The problems identified above can be solved by using a proxy server to store already transmitted pictures in the network. The proxy will keep copies of sent pictures and avoids the need to transmit large files over the radio interface several times. Furthermore, the proxy server can be easily configured to have high computational power available, in which case the pictures can be easily adapted to the capabilities of various receiving terminals. Typically, the proxy will sit within the mobile operator's network and may be co-located with the MRFP

Example rules for the proxy operation are as follows:

1. All pictures transmitted across a network at least once are stored in the proxy server of that network for a predetermined time.

2. When a mobile terminal detects that the user is trying to share a picture with another party that has been shared before (with that or another party), the terminal will transmit a hash (or a check sum) of the file to the proxy server. The hash can be relatively small, of the order of tens of bytes.

3. Upon receiving the hash, the proxy server will replace the hash with the cached copy of the picture, and forward the message to the recipient.

4. If the proxy server does not have a cached copy of the picture, the proxy server will request the sender to transmit the original picture to the proxy server, where a copy is cached before forwarding the picture to the recipient.

This procedure is illustrated in the right hand messaging flow of FIG. 2, with the left hand illustration demonstrating the prior art approach.

It can be expected that certain files (e.g. video clips of a football goal or a fun commercial) will be very popular amongst users and will potentially be transmitted to a given user during several calls with other different users. It may be difficult for users to know if a particular content has been downloaded before and is available on his or her phone or not, and potentially a user has to wait for/pay for a given content several times.

A solution to this problem is to calculate at the sending terminal a signature, e.g. checksum or content id, for a picture/video clip before it is transmitted. This may be computed from the image data itself, e.g. a hash of the data. Before sending the actual content, only the signature is transmitted, followed by the content if necessary. By checking the signature the user application at the receiver can check if the content has already been received and if it is available in the device. If so download of the file can be aborted.

Alterative solutions are possible:

1) The signature is calculated from the content in such a way that it does not include the file name, i.e. even if the file name is changed it will be recognised as a duplicate.

2) Instead of computing the signature from the image data itself, the signature may be data independent, being generated when the content is created (e.g. a random number). This solution may be less complex.

The invention also applies to normal internet mail where the same document or file can be received several times without the user knowing if it is already available or not.

1. A method of optimising the use of transmission bandwidth in a communication system, the method comprising, for data to be sent via an interface from a first to a second node;
determining at said first node whether or not the data has been sent previously to said second node or another node;
if the data has been previously sent, generating a signature for the data content, sending the signature from the first to the second node or to an intermediate node in the transmission path, at the second node or said intermediate node comparing the signature to signatures for data stored at that node, and sending the data from the first to the second node, via said interface, only if the received signature does not match a signature for stored data; and
if the data has not been previously sent, sending the complete data to said second node.

2. A method according to claim 1, wherein said communication network is a mobile wireless communication network, and said interface is the air interface.

3. A method according to claim 1, wherein said data corresponds to any one of a still image, a video image, and an email.

4. A method according to claim 1, wherein said first and second nodes are user terminals, and said intermediate node is present and acts as a proxy server, caching data which is sent between user terminals for the first time, and in the event that the received signature matches a signature for stored or cached data, the data is sent to the second node by the intermediate node

5. A method according to claim 1, wherein said second node is a user terminal and said first node is a node at which content is stored, said signature being generated at the first node and being sent to the second node, wherein, based upon the signature comparison, the second node is able to determine whether or not it has already received the data which is intended to be sent, and if the data has already been sent, the further sending can be aborted.

6. A method according to claim 1, wherein said data is multimedia data which is sent during a circuit switched voice call between the first and the second nodes.
